(19) United States
(12) Patent Application Publication
(10) Pub. No.: US 2004/0014528 A1
(43) Pub. Date: Jan. 22, 2004

(54) Memory retrofit apparatus for portable game devices

(76) Inventor: Richard Leifer, Melville, NY (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/195,590

(22) Filed: Jul. 16, 2002

(51) Int. Cl. A63F 13/00

(52) U.S. Cl. 463/44

(57) ABSTRACT

A memory retrofit device for connection to a portable game device that provides the game device with memory capacity and capability. The memory can be internal to the device or may be removable in the form of a card or cartridge. In one embodiment, the memory device connects to the communication port of the portable game device and enables complete communication with the portable game device and game being played in the same. In another embodiment, the game cartridge slot is used to connect the memory device to the portable game device. The game cartridge plugs into an additional game cartridge slot provided on the memory device and is thereby connected to the portable game device.

### BACKGROUND OF THE INVENTION

1. Field of the Invention

The present invention relates to portable gaming devices. More particularly, it relates to providing memory capacity to a portable gaming device.

2. Description of the Prior Art

Portable game devices that have the ability to change games using cartridges have become commonplace in the video game industry Examples of such portable game devices can be shown by the Nintendo GAME BOY™ and GAME BOY ADVANCE™.

In stark contrast to the console video game world, one common feature or shortfall for these portable game devices is the inability to save a game and return to the same at a later time. The portable game devices do no have the ability to save a game and or allow the user to achieve higher levels and save the same for later retrieval.

Thus, there is a need to add memory features to a portable game device without interfering with the game operation and without significantly altering the aesthetic design of such portable game device.

### SUMMARY OF THE INVENTION

It is therefore an object of the invention to provide a memory retrofit device that is connectable to a portable game device and provides the same with memory capacity and capability.

It is another object of the invention to provide memory retrofit device for portable games that does not interfere with the use of the controls of the game device.

It is yet another object of the invention to provide a memory retrofit device for portable games that does not significantly alter the aesthetic design of the portable game device.

These and other objects are achieved in accordance with an embodiment of the present invention wherein the memory device for portable game devices having a communication port, includes a housing having a plug insertable into the communication port of the portable game device, and a memory contained within the housing for storing information from the portable game device.

According to another embodiment, the memory device for portable game devices having a game cartridge slot includes a housing having a slot engaging portion insertable into the game cartridge slot of the portable game device and an additional game cartridge slot for receiving game cartridges when said slot engaging portion is inserted into the game cartridge slot of the portable game device, and a memory contained within said housing for storing information from the portable game device.

In alternative embodiments, the housing contains a memory cartridge slot and a memory cartridge is removably inserted into the slot to add memory capability to the portable game device.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a perspective view of a hand held video game device;

FIG. 2 is top edge view of the hand held video game device;

FIG. 3 is a rear view of the hand held video game device;

FIG. 4 is a rear view of the hand held video game device with the battery compartment cover removed;

FIG. 5 is a perspective view of the memory retrofit device according to an embodiment of the invention;

FIG. 6a is a side view of the memory retrofit device of FIG. 5;

FIG. 6b is a side view of a modified embodiment of the memory retrofit device of FIG. 5;

FIG. 7 is a perspective view of the memory retrofit device according to another embodiment of the invention;

FIG. 8a is a side view of the memory retrofit device of FIG. 7;

FIG. 8b is a side view of a modified embodiment of the memory retrofit device of FIG. 7;

FIG. 9 is a top view of a memory retrofit device according to another embodiment of invention;

FIG. 10 is a top view of a memory retrofit device according to yet another embodiment of the invention; and

FIG. 11 is a plan view of a memory/rumble retrofit device according to an embodiment of the invention.

### DETAILED DESCRIPTION OF PREFERRED EMBODIMENTS

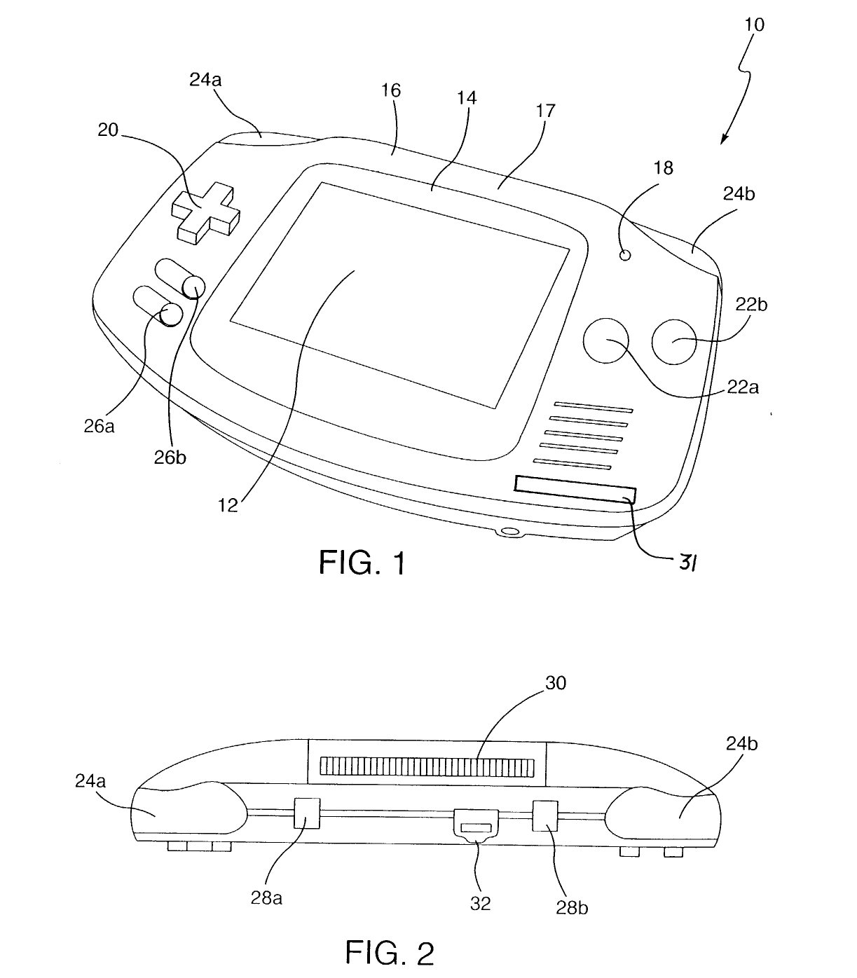

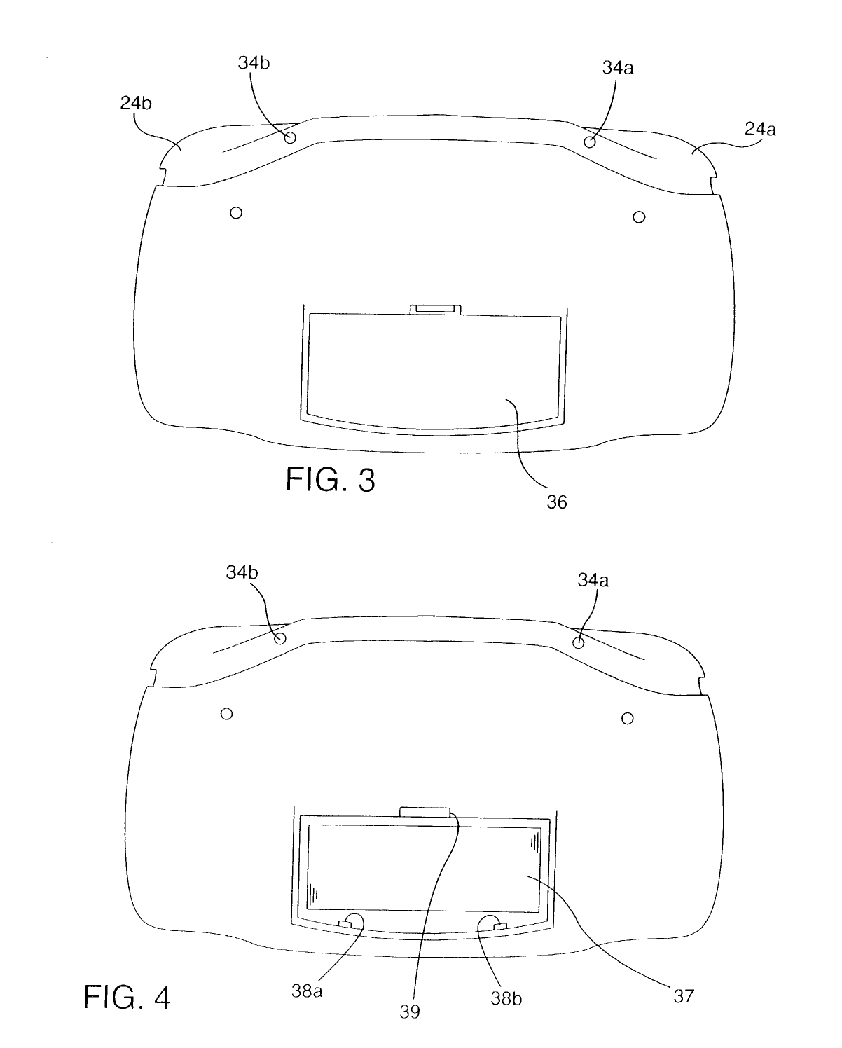

Referring to FIGS. 1 through 4, there is shown a portable game device 10 that is representative of a new generation in portable game devices. This exemplary portable game device 10 is manufactured by Nintendo and is commonly known as the GAME BOY ADVANCE™. The portable game device 10 includes a video display screen 12, a display screen border 14 and a housing 16. A power indicator 18 lights up when the power to the game device is on, and control D-pad 20 and control buttons 22a, 22b, 24a and 24b enable user control of a video game being played.

An additional communication or game controller port 31 may be provided on the portable game device 10 for providing a connection point to various other peripheral devices or controllers. Controller port 31 can be used to attach a peripheral game controller such as a genre specific controller to the portable game device depending on the game being played. For example, a first person shooting (FPS) game is preferable played with a joystick type of controller.

The game controller port 31 can be established such that the insertion of a peripheral controller allows the same to control a game being played by the portable game device. In addition, when the portable game device is connected to a larger video display device (not shown), the additional game controller port 31 can be used to connect a game control device that will allow either single user or dual user action that can be observed on the large video display device. In a dual user mode with an external video display device, a single portable game device can provide two user gaming action.

Those of ordinary skill in the art will recognize that various other types of genre specific game controllers can also be implemented without departing from the spirit of the invention.

The top edge of game device 10 shows the disposition of the game cartridge slot 30 on the rear of the device and communication port 32 on a top edge thereof. A pair of indents 28a and 28b are also disposed on the top edge. On the rear of device 10, there are screw holes 34a and 34b through which screws (not shown) secure the game device together during assembly. The battery compartment 37 is disposed on the rear of the game device and includes a battery compartment cover 36 enclosing the same. As is known in the art, battery compartment 37 includes openings 38a and 38b and 39 for receiving corresponding parts of the battery compartment cover 36 to secure the same to the game device.

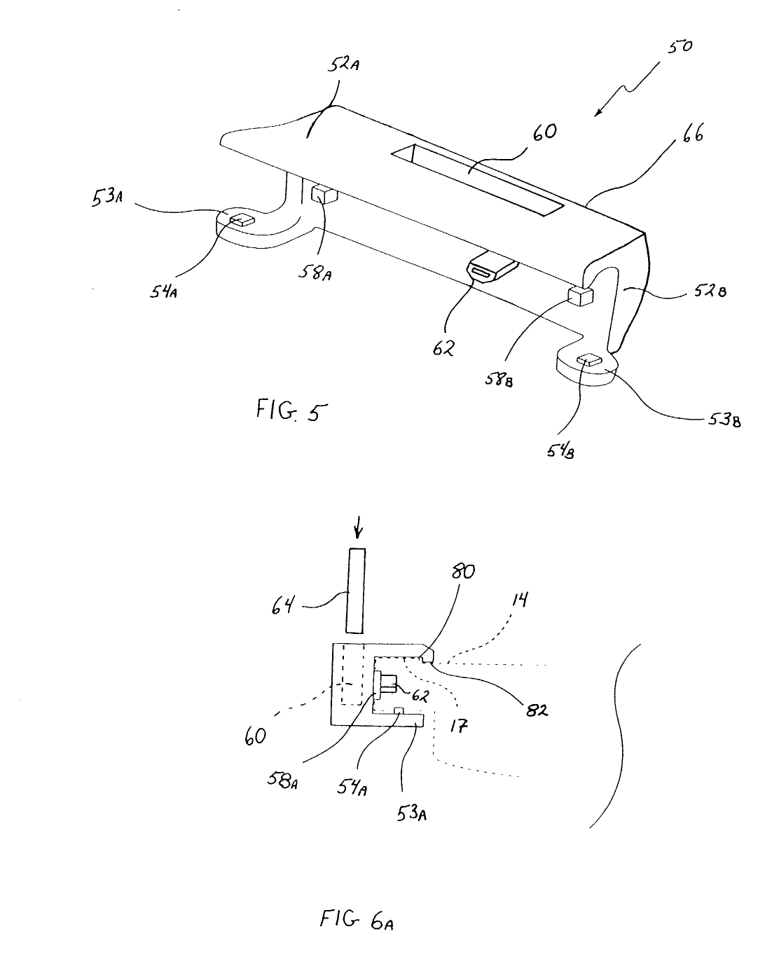

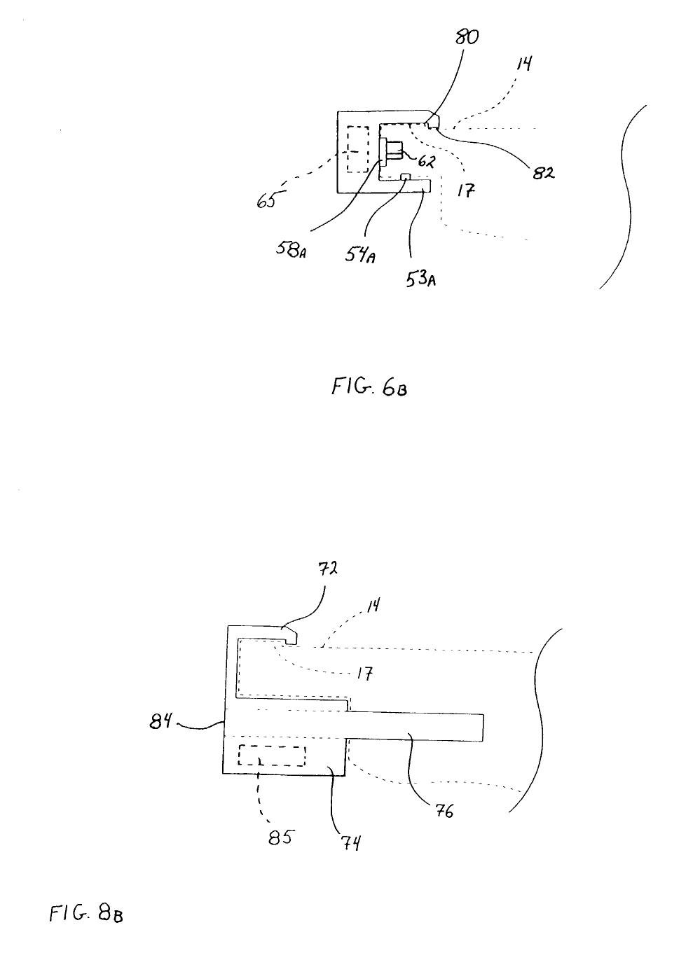

FIG. 5 shows the memory retrofit connector 50 according to an embodiment of the invention. Connector 50 includes an upper portion 52a adapted to engage over the top edge of the game device 10 and secure over the transitional front top edge 17 of housing 16 and onto the video display border 14 (to be discussed later with reference to FIG. 6). An intermediary portion 52b connects the upper portion 52a to the lower portion formed by a pair of extensions 53a and 53b. Extensions 53a and 53b of the lower portion are provided to grip the underside of the game device while the upper portion 52a engages the top of the game device. Extensions 53a and 53b include corresponding detents 54a and 54b that are shaped and positioned to engage the screw holes 34a and 34b in the back of the game device. In addition, another pair of detents 58a and 58b are positioned on the inside of connector 50 so as to engage the corresponding indents 28a and 28b in the top edge of the game device.

In one embodiment, the upper portion 52a of connector 50 includes a memory cartridge receiving slot 60 and a plug 62 for engaging the communication port 32 on the portable game device. A memory cartridge 64 is insertable into slot 60 and will enable the user to store and retrieve various game information, such as, for example, games, game levels and credits for achieving various aspects of a given game. In this manner, the user will be able to retrieve previous game information and “go back” to where they left off the last time they were playing the game. In another embodiment (FIG. 6b), the memory 65 is internal to the connector 50 and cannot be removed therefrom.

The use of “memory” throughout this disclosure generally refers to a random access memory (RAM) of any suitable known type. For example The communication port 32 provides the connector 50 and thus memory cartridge slot 60 with full communication with the game device and any game that is being played by the same. Thus, when memory cartridge 64 (FIG. 6) is inserted into slot 60, it will be in complete communication with the portable game device via port 32. On the rear of connector 50 is an additional communication port 66 that provides the user with access to the communication port 32 when plug 62 is disposed therein with connector 50 attached to the game device.

Referring to FIGS. 5 and 6a, when connector 50 is attached to the game device 10, the detents 54a and 54b engage screw holes 34a and 34b while extensions 53a and 53b of the lower portion do not interfere with the access to the game cartridge slot 30. As shown in FIG. 6, the display border 14 is slightly recessed from the front top edge 17 of housing 16. The upper portion 52a of the connector includes an underside 80 that passes over front top edge 17 and at the point of transition between front top edge 17 and display border 14 (i.e., where the display boarder is recessed), a downward protrusion 82 snaps over the ledge formed between front top edge 17 and display border 14. This “snap over” feature operates in conjunction with the detents 54a, 54b, 58a and 58b to secure connector 50 onto the top edge of the game device. The detents 54a, 54b, 58a and 58b also operate to laterally secure the connector 50 to the game device and prevent sliding of the same along the top edge of the game device.

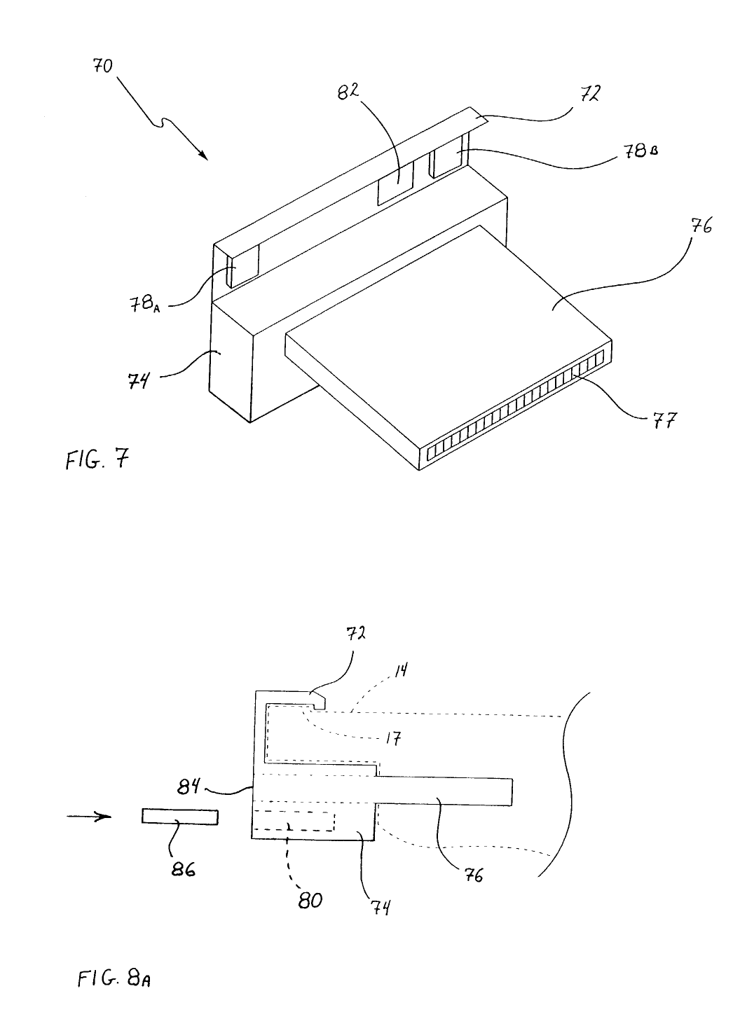

FIGS. 7 and 8 shows the connector 70 according to another embodiment of the invention. Connector 70 includes an upper portion 72, a main portion 74 connected to the upper portion 72 and a game cartridge slot engaging portion 76 connected to the main portion 74. The upper portion 72 may include detents 78a and 78b that operate as explained previously to engage the corresponding indents 28a and 28b on the top edge of the game device. In addition, upper portion 72 can be adapted to engage the top edge of the game device as previously described with reference to the embodiment of FIG. 6.

An opening 84 in main portion 74 receives the game cartridge that would otherwise be disposed in slot 30 and is now occupied with slot engaging portion 76. The slot engaging portion 76 includes a connector 77 that matingly engages the game cartridge slot 30 and allows the connector to be in complete communication with the game device and game being played. A window or opening 82 in the upper portion 72 allows for access to the communication port 32 while the memory connector 70 is disposed in its operable position on in the game cartridge slot 30 of the game device.

In the embodiment depicted in FIG. 8a, the main portion 74 also includes a memory card slot 80 for receiving a memory card 86. In another embodiment (FIG. 8b), the memory 85 is built into the body of connector 70. Those of skill in the art will recognize that the size of memory card 86 or internal memory 85 is a matter of design choice and can be varied without departing from the spirit of the invention.

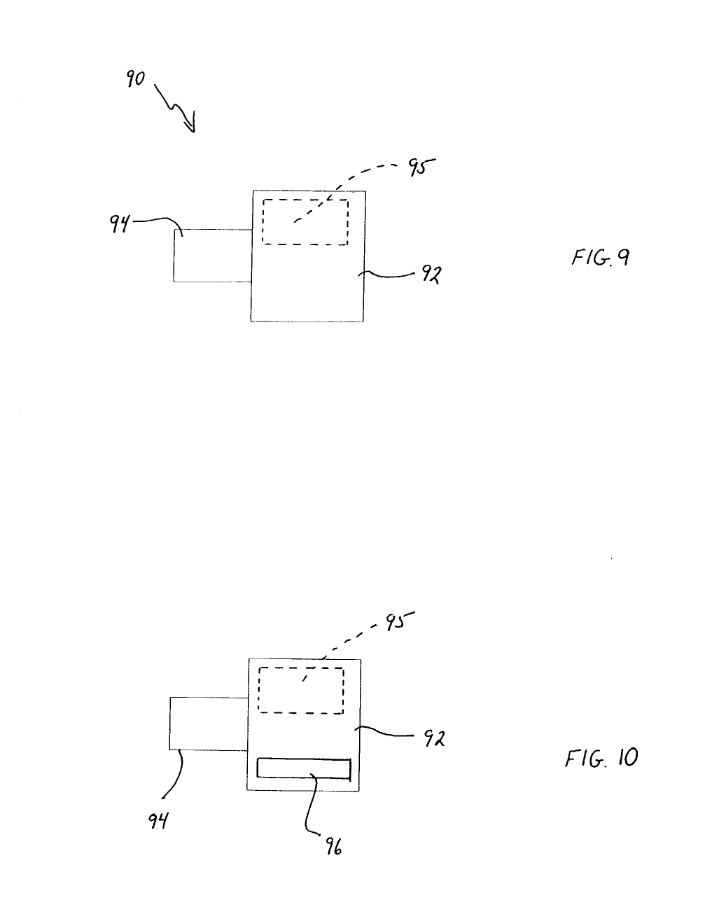

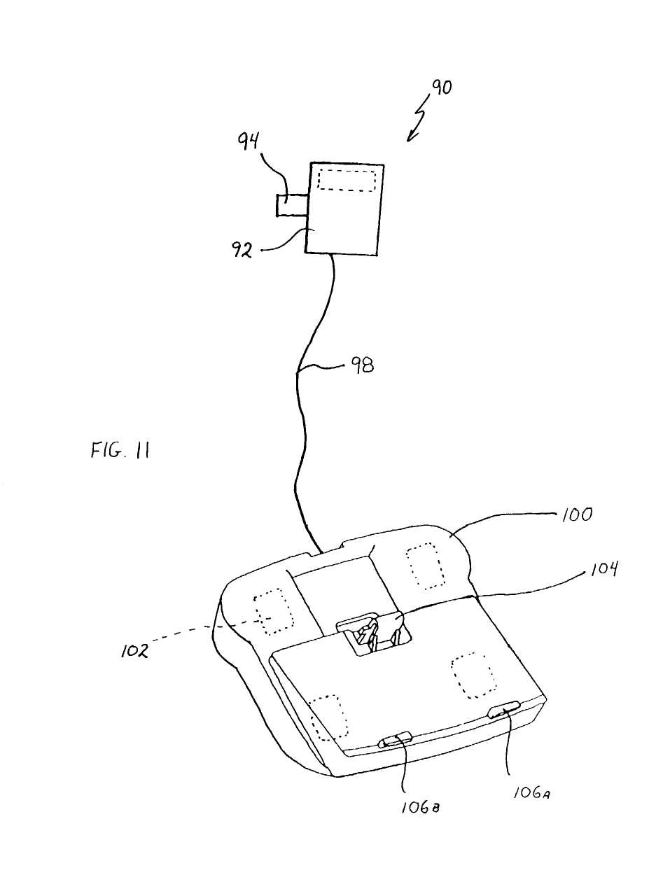

FIGS. 9 and 10 shows another memory connector 90 according to the present invention. Connector 90 includes a main body 92 with a plug 94 adapted to be connected to the communication port 32 of the portable game device. In one embodiment, an internal memory is contained within body 92 and is in communication with the portable game device via the plug 94 and communication port 32. As mentioned previous, the size of the internal memory can be varied without departing from the spirit of the present invention.

FIG. 10 shows memory connector 90 having a memory cartridge slot 96 in main body 92. The memory cartridge slot receives a memory cartridge (card, etc.) and thereby enables the portable game device to utilize the same to enhance the users gaming experience.

FIG. 11 shows a modified memory connector 90 having an additional rumble pack 100 connected to the same via a wire 98. Rumble pack 100 includes at least one internal vibrating member 102 that responds to game information transmitted through the connection of connector 90 to communication port 32 of the portable game device via plug 94. Rumble pack 100 can be connected to the portable game device by replacing the battery compartment cover 36. Rumble pack 100 includes a clip 104 and that engages snaps securely into opening 39, while detents 106a and 106b engage corresponding openings 38a and 38b. In this manner, rumble pack 100 is attached to the rear of the portable game device and provides tactile feedback to the entire game and user holding the same.

While there have been shown, described and pointed out fundamental novel features of the invention as applied to preferred embodiments thereof, it will be understood that various omissions, substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed, described or suggested form or embodiment as a general matter of design choice. It is the intention, therefore, to be limited only as indicated by the scope of the claims appended hereto.

What is claimed is:

1. A memory device for portable game devices having a communication port, the memory device comprising:
a plug insertable into the communication port of the portable game device; and
a memory contained within said plug for storing information from the portable game device.

2. The memory device according to claim 1, wherein said memory is removable from said plug.

3. The memory device according to claim 1, wherein said plug includes a housing, said housing further comprising:
an upper portion, a lower portion and an intermediary portion connecting said upper and lower portion, each of said portions having an internal and an external surface;
first connection means integrally formed with said lower portion for engaging a back of the portable video game device;
second connection means integrally formed with said upper portion for engaging a front of the portable video game device; and
securing means disposed on at least one of said upper, intermediary and lower portions for laterally securing the housing to the top edge of the portable video game device.

4. The memory device according to claim 3, wherein said first connection means comprises at least one detent disposed on the internal surface of said lower portion for engaging at least one screw hole in the back of the game device.

5. The accessory connector according to claim 3, wherein the portable video game device further comprises a video screen, a cover panel covering the video screen and a front top edge extending from said cover panel to the top edge, said cover panel being slightly recessed from said upper edge to form a ledge, said second connection means comprising an elongated upper surface having a downward extending flange adapted to snap over the upper edge of said compact computer device and engage the ledge formed between said upper edge and the cover panel.

6. The accessory connector according to claim 3, wherein said securing means comprises at least one detent disposed on said internal surface of said intermediary portion, said at least one detent engaging a corresponding indent in the top edge of the portable game device.

7. The accessory connector according to claim 3, wherein said lower portion engages the back of the portable game device and includes a pair of extensions flared outward from said intermediary portion and positioned so as to not interfere with a game cartridge slot disposed on the back of the portable game device.

8. The memory device according to claim 1, wherein said plug further comprises an additional communication port receptacle accessible by a user when said plug is inserted into the communication port of the portable game device.

9. The memory device according to claim 1, further comprising a vibrating peripheral device electrically connected to said plug for providing tactile feedback to the portable game device in response to game information transmitted through said communication port.

10. The memory device according to claim 9, wherein said vibrating peripheral device comprises a housing releasably connectable to said portable game device and at least one vibrating member contained within said housing.

11. A memory device for portable game devices having a game cartridge slot, the memory device comprising:
a slot engaging portion insertable into the game cartridge slot of the portable game device and an additional game cartridge slot for receiving game cartridges when said slot engaging portion is inserted into the game cartridge slot of the portable game device; and
a memory device for storing game information related to the portable game device.

12. The memory device according to claim 11, wherein said memory is removable.

13. The memory device according to claim 11, further comprising a housing and a vibrating member contained within said housing, said vibrating member providing tactile feedback to the portable game device in response to game information received from the portable game device.
